(19) United States
(12) Patent Application Publication
(10) Pub. No.: US 2007/0257889 A1
(43) Pub. Date: Nov. 8, 2007

(54) DISPLAY LIT SOFT KEYS THAT HAVE MULTIPLE STATES OF ACTIVATION POTENTIALLY ASSOCIATED WITH EACH SOFT KEY

(76) Inventor: Clemens Croy, Frankfurt (DE)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/743,635

(22) Filed: May 2, 2007

Related U.S. Application Data
(60) Provisional application No. 60/798,348, filed on May 5, 2006.

(51) Int. Cl. G09G 5/00

(52) U.S. Cl. 345/170

(57) ABSTRACT

Various methods, apparatuses, and systems are described for soft keys that have multiple states of activation potentially associated with each soft key and are illuminated by light coming from the display.

### RELATED APPLICATIONS

This application claims the benefit of U.S. Provisional Application No. 60/798,348 filed on May 5, 2006.

### FIELD OF THE INVENTION

Aspects of some embodiments of the invention generally relate to soft keys lit by a display.

### BACKGROUND

Some devices may exist that implement soft keys that have a separate light source for illumination of keys than the light source illuminating the display. Hand held or mobile devices powered by a Direct Current (DC) power source would have additional power consumption, which shortened the time period needed between re-charging the DC power source. These mobile devices also have no connection between the lighting of the soft keys and the execution status of a particular soft key.

### SUMMARY

Various apparatuses, systems, and methods are described to guide a user on navigating through any control options for an application. This will provide the user with a visual indication in illumination of selected soft keys of what selection options are available to control that particular application. In an embodiment, an apparatus is described that has a display, a set of soft keys that have an associated function in a legend section on the display, one or more optical fibers, and a user interface. Each key in a set of two or more soft keys may have an associated function in a legend section on the display. Each soft key in that set may comprise both 1) a physical key having at least a portion that is capable of being illuminated and 2) the physical key is associated with a current function in the legend section displayed on the display for that physical key. One or more optical fibers may propagate light emitted from a portion of the display to the physical portion capable of being illuminated of a corresponding soft key. Each physical key that has a portion capable of being illuminated receives the light from at least one of the optical fibers. The light projects through the display and propagates through an optical fiber to the soft key associated with that optical fiber in order to visually indicate a state of the soft key. When a state of the current function in the legend section associated with the soft key changes, then visually an illumination characteristic of the soft key changes through illumination of the portion of the physical key capable of being illuminated. The user interface presents the current functions in the legend section in order to provide the visual indication in the soft key that will guide a user on navigating through any control options for an application presented by the user interface by giving the user a visual indication in illumination of selected soft keys from the set of soft keys of what selection options are available to control that particular application.

### BRIEF DESCRIPTION OF THE DRAWINGS

The drawings refer to embodiments of the invention in which:

FIG. 1 illustrates an embodiment of a hand-held remote-control having a plurality of soft keys to generate commands from the hand held remote.

FIG. 2 illustrates an embodiment of a hand-held remote-control having a plurality of soft keys that each may have multiple states of activation and glow a same color or amount of light that is illuminated by the legend section associated with that soft key.

FIG. 3 illustrates an embodiment of a cross sectional view of hand-held remote-control having a plurality of soft keys illuminated by the display.

FIG. 4 illustrates the handheld using the personal navigator interface key lighting system may cooperate with docking systems in a mobile transportation environment such as a car and airplane, and in the home and office.

FIG. 5 illustrates an embodiment of a device having a display using the personal navigator interface key lighting system permanently installed in, for example, the dash board of the automobile.

While the invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives failing within the spirit and scope of the invention.

### DETAILED DISCUSSION

In the following description, numerous specific details are set forth, such as examples of specific signals or colors, named components, connections, etc., in order to provide a thorough understanding of the present invention. It will be apparent, however, to one of ordinary skill in the art that the present invention may be practiced without these specific details. In other instances, well known components or methods have not been described in detail but rather in a block diagram in order to avoid unnecessarily obscuring the present invention. The specific details set forth are merely exemplary. The specific details may be varied from and still be contemplated to be within the spirit and scope of the present invention.

In general, various apparatuses, systems, and methods are described for a user interface that guides a user on navigating through any control options for an application by giving the user a visual indication in illumination of selected soft keys of what selection options are available to control that particular application. The soft keys may have multiple states of activation potentially associated with each soft key and may be illuminated by light coming from a display. In an embodiment, an apparatus is described that has a display, a set of soft keys that have an associated function in a legend section on the display, one or more optical fibers, and a user interface. Each key in a set of two or more soft keys may have an associated function in a legend section on the display. Each soft key in that set may comprise both 1) a physical key having at least a portion that is capable of being illuminated and 2) the physical key is associated with a current function in the legend section displayed on the display for that physical key. One or more optical fibers may propagate light emitted from a portion of the display to the physical portion capable of being illuminated of a corresponding soft key. Each physical key that has a portion capable of being illuminated receives the light from at least one of the optical fibers. The light projects through the display and propagates through an optical fiber to the soft key associated with that optical fiber in order to visually indicate a state of the soft key. When a state of the current function in the legend section associated with the soft key changes, then visually an illumination characteristic of the soft key changes through illumination of the portion of the physical key capable of being illuminated. The user interface presents the current functions in the legend section in order to provide the visual indication in the soft key that will guide a user on navigating through any control options for an application presented by the user interface by giving the user a visual indication in illumination of selected soft keys from the set of soft keys of what selection options are available to control that particular application.

The user interface may be touch-sensitive, preferably in its portions where functions in the legend section may be displayed. Then, it may be possible to activate a currently available function(s) by touching or contacting, e.g. by a user's fingers, the respective portion(s) of all users interface and/or by pressing the respective area on the display where the function(s) appears. Such embodiments allow users to activate available functions according to, e.g., personal preferences (for example, some might prefer touch-input via the user interface, while others prefer to use a “physical portion of the soft key). Displays operated with a user interface and having touch-sensitive input functions may become dirty or grubby due to contact with fingers and hand portions of a user. Using the soft keys may avoid such effects. In some applications, the user interface might have small dimensions. Then it might be difficult to precisely touch/contact a respective portion of the user interface to activate an available function. Also, the dimensions of the area on the display illuminating the function might be such that touching/contacting a user interface's potion could (at least partially) cover the respective function, whereby visual feedback control is limited or not possible. Using the soft keys avoids such problems. Further, the soft keys provide for a tactile and /or haptic feedback for users for activation (e.g. a soft key may be selected by feeling its shape) and upon activation (e.g. pressing a soft key may provide a direct physical feedback).

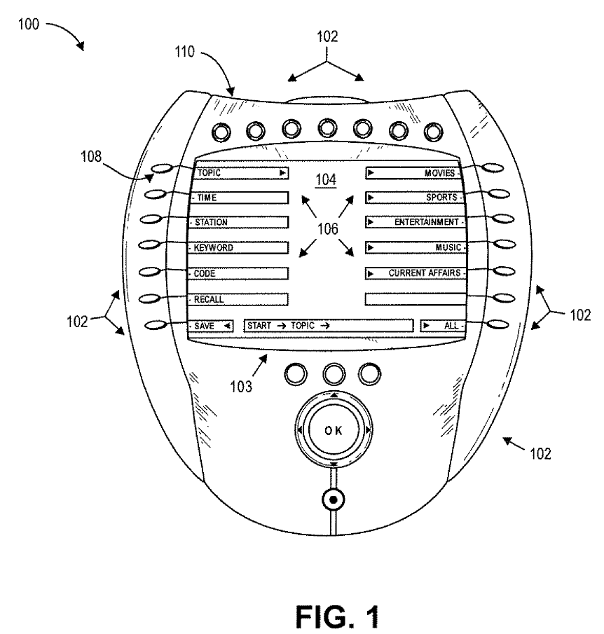

FIG. 1 illustrates an embodiment of a hand-held remote-control having a plurality of soft keys to generate commands from the hand-held remote-control. The hand-held remote-control 100 may include a plurality of soft keys 102, a display 104, and legend sections 106 on the display 104 associated with the soft keys 102. The soft keys 102 are located adjacent to a display screen or display readout that displays a function selected when the soft key is pressed. Each soft key, such as the first soft key 108, comprises both a physical key having at least a portion that is capable of being illuminated and a current function in the legend section 106 displayed on the display 104 for that physical key. The same physical key becomes associated with the function currently displayed on the screen and the function on the screen may change as other soft keys 102 are depressed. Each soft key may be composed of translucent material such as the first soft key 108 or have a ring of translucent material around the physical key such as a second soft key 110.

An optical fiber couples light from the face of the display screen 104 to the translucent physical keys and/or to the associated ring of translucent material around the physical keys. The display 104 may illuminate a plurality of functions, such as icons, titles, etc., associated with each soft key in the legend section 106. The light projected through the display 104 tends to indicate the state of the soft key associated with those functions. Example functions are topic, time, station, keyword, music, movies, etc.

As the availability or even the state of the legend section 106 of the display 104 changes, typically, a color change of that legend section 106 will change on the display 104. Alternatively, other optical or visual changes such as the intensity of the light, a solid or blinking pattern, a lit or unlit state, or similar visual indication of that legend section 106 could be used to signify a change on the display 104. Thus, as the availability or even the state of a legend section 106 of the display 104 changes, then that change in color will also be shown in the associated translucent soft key.

The hand-held remote-control may also have a progress bar 103 to hierarchically indicate where the user is in the progression of navigating the control options for an application.

The actual soft key that needs to be depressed by the user may have multiple states associated with that key and will glow to give the user another sensory indication of the current state of that key. Further, when one soft key is depressed, then that allows several more options to be enabled after the initial key is depressed. The soft keys 102 associated with the newly enabled options will light up on the display 104 in the associated legend sections 106 and the soft keys 102 will glow themselves. Overall, the user is more easily able to focus on soft key choices during the navigational process of selecting commands with the remote control. The lit up soft keys 102 guide the way.

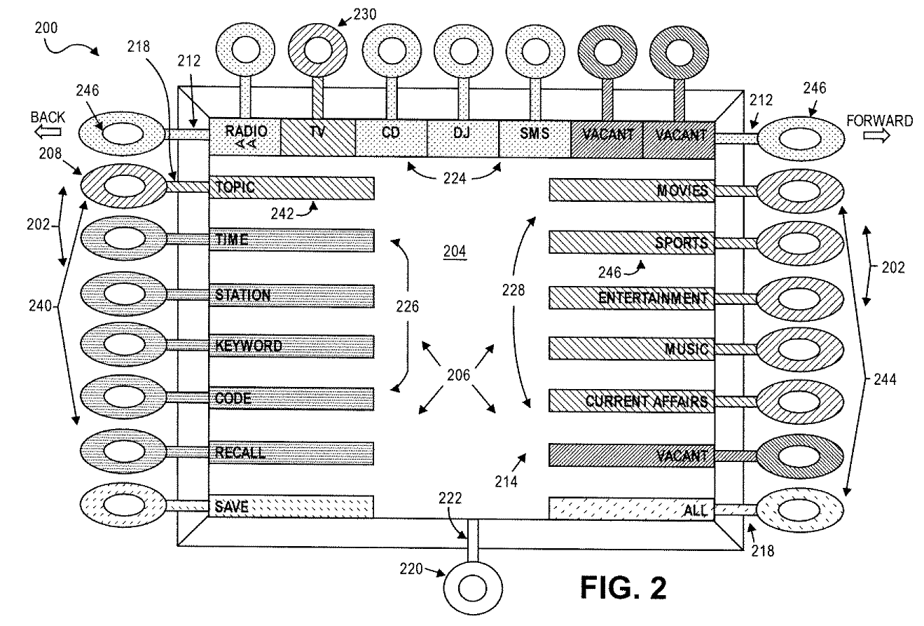

FIG. 2 illustrates an embodiment of a device having a plurality of soft keys that each may have multiple states of activation and visually indicate whatever the legend section 206 associated with that soft key is illuminating. The device 200 includes a display 204, a set of soft keys 202 that have an associated function in a legend section 206 on the display 204, one or more optical fibers 212, a user interface 214 and other similar components. Each soft key in the set of two or more soft keys 202 may have an associated function in the legend section 206 on the display 204 Thus, the first soft key 208 is associated with the topic function in the legend section 206 on the display 204. One or more optical fibers 212, such as a first optical fiber 218, may propagate light emitted from a portion of the display 204 to the physical portion of a corresponding soft key capable of being illuminated.

Each physical key that has a transparent portion capable of being illuminated receives the light from at least one of these optical fibers 212. The optical fiber 212 couples to the display 204 at the legend section 206 associated with that soft key. The light projects through the display 204 and propagates through the optical fiber to the soft key associated with that optical fiber in order to visually indicate an activation state of the soft key. When the state of the current function in the legend section 206 associated with the soft key changes, then visually an illumination characteristic of the soft key changes through illumination of the transparent portion of the physical key capable of being illuminated. The visual indication in illumination characteristics include a change in color of the illuminated portion of the physical key, a change in an intensity of the light from the illuminated portion of the physical key, a pattern conveyed by a lighting sequence of the illuminated portion of the physical key, and combination thereof.

The user interface 214 presents the current functions in the legend section 206 in order to provide the visual indication in the soft key that will guide a user on navigating through any control options for an application presented by the user interface 214 by giving the user a visual indication in illumination of selected soft keys from the set of soft keys 202 of what selection options are available to control that particular application.

Thus, the user interface 214 merely illuminates selected physical keys that have a transparent portion that is capable of being illuminated in order to ease a user's focus on the soft key selection from the set of potential soft keys 202 to depress. The user interface 214 illuminates the transparent portion of the physical key that is capable of being illuminated to navigate the user to select soft keys 202 that currently have an available function associated with that soft key in the legend section 206. Thus, the user is guided to the available commands associated with an application visually by illumination of both the functions in the legend section 206 on the display 204 and the illumination of the transparent portion of the associated soft keys 202.

A ping-pong type of interdependent connectivity exists between the display screen information and soft key choice. The operation of the set of two or more soft keys 202 and illumination of those two or more soft keys 202 is interdependent with other soft keys 202. The soft keys are interdependent because as the initial soft key is depressed that allows one or more new functions in the legend section 206 to be enabled after the initial soft key is depressed. The user interface 214 causes newly enabled selectable functions to appear on the display 204 in the associated section of the legend section 206. The illumination of the newly enabled selectable functions in the legend section 206 causes one or more soft keys associated with the newly enabled selectable functions to now illuminate themselves as well as cause one or more soft keys associated with functions that are no longer available to not illuminate.

When a soft key is asserted via physical touch, receipt of wireless control signal, speech signal, on-screen touch with touch screen technology, etc., then the soft key may give a visual feedback signal that the soft key has been asserted to provide assurance and ease of operation whilst providing off display screen feedback of an executed task. Thus, an actual key that needs to be depressed by the user that has multiple states associated with that key, can give a second visual indication such a glowing giving the user another sensory indication of the current state of that key. As noted, the presented functions on the display 204 are interdependent upon what soft key was previously actuated. As one soft key is depressed, then that may allow several more options to be enabled after the initial key is depressed. The soft keys 202 associated with the newly enabled options will light up on the display 204 in the associated legend sections 206 and the soft keys 202 will glow themselves.

An example implementation of the operation of the interdependent soft keys and illumination of those soft keys may be as follows.

In step 1, a user may turn the hand-held remote-control 200 on by depressing the third soft key 220 associated with an on/off function.

In step 2, the display 204 may activate and consequently illuminate. This illumination is coupled through a second optical fiber 222 to the on/off soft key 220. The coupled light makes the transparent portion of the on/off soft key 220 glow perhaps a first color such as blue. Also, a list of available applications 224 that the hand-held remote-control 200 can send commands 226, 228 to illuminates in the legend section 206 across the top of the display screen. The functions in the legend section 206 may be split up into distinct two or more parts including a first section of the legend section 206 for applications 224 controllable by the hand-held remote-control device 200 and a second section of the legend section 206 for command options 226, 228 a user may currently choose for a particular application selected in the first section of the legend section 206 for applications 224. Each application, such as radio, television, CD player, DJ, SMS, and potentially other applications, may illuminate in an initial color such as green (indicated on FIG. 2 as a speckled green for the soft keys going horizontally across FIG. 2). For soft keys that have no command or application associated with that soft key at this point in time, those functions in the legend section 206 illuminate in a different color such as grey or do not illuminate at all (indicated by the naturally gray transparent soft keys labeled as vacant).

In step 3, the user may depress one of the soft keys corresponding to an application that has an associated active function in the legend section 206 being illuminated on the display 204. Thus, the user may select to send commands 226, 228 to one of the applications 224 that cooperate with this hand-held remote-control 200. In this example, the user depresses the fourth soft key 230 associated with the television application. The function in legend section 206 of the display 204 changes color to indicate that the television application has been selected. The color of the activated and selected application may change to a second color, such as purple. (This is indicated by the purple slotted line in the soft keys on the left hand side of FIG. 2 and the selected TV application soft key in the top of FIG. 2.) Along the left hand side of the display a vertical list of potential commands 226 associated with the television application in the legend section 206 are now illuminated on the display 200. The change in the status of these commands 226 to an active state is also illuminated on the soft keys 230, 240 associated with these commands 226. The soft keys 230, 240 glow the same color as the selected application in the legend section 206 on the display 204. The corresponding commands 226 in the legend section 206 on the display 204 illuminate the same color as the color of the selected TV application, which is purple.

In an embodiment, the user interface causes some selective soft keys to be lit up and some soft keys with no current function available to not be lit up or glow a different color rather than all of the soft keys lighting up. Also, the set of lit up potential keys to depress will generally change because of the interdependency of the keys and the associated information on the display screen 204. As a state of a soft key changes from being depressed, the function in the legend section 206 of the display 204 may change. The function in the legend section 206 of the display 204 changing provides a second visual indication that a particular soft key was activated. The selection of lit up soft keys guides a user in making the next step of soft key choice. This provides focus, assurance, and ease of operation whilst providing off screen feedback of an executed task.

In step 4, the user may depress one of the soft keys listing a command 226 for the application that has an associated active function in the legend section 206 being illuminated on the display 204. The user may depress, for example, the soft key 208 now associated with the command 242 “Topic” in the legend section 206. The “Topic” legend section of the display will change colors from purple to a third color, for example pink. (This is indicated by the pink hash markings in FIG. 2). Along the right hand side of the display a vertical list of potential commands 228 associated with the “Topic” command in the television application are now illuminated on the display 204. The change in the status of these commands 228 to an active state is also illuminated on the soft keys 244 associated with these commands 228. The soft keys 244 glow the same color as the selected command, such as “Topic”, in the legend section 206 on the display 204. These commands functions 228 on the display 204 illuminate the same color as the color of the selected command, which are pink hash markings.

In step 5, the user may depress one of the soft keys listing a specific command function for the application that has an associated active legend section being illuminated on the display. The user may depress, for example, the soft key associated with the command function 246 “Sport” in the legend section 206 The command function 246 labeled “Sport” changes colors to a fourth color, for example red. (This is indicated by a diagonal hash marking in FIG. 2). This could bring up another set of command options for the user to select. The soft keys associated with this new set of commands would illuminate the same color (i.e. red) as the legend sections display. The user is guided to the available commands visually by illumination of both the legend section on the display and the illumination of the associated soft key(s). A change in color was used in this example, but a change in any illumination characteristic may be used to visually guide a user in the selection of soft keys. The hand held device 200 may also have back and forward buttons to assist a user in navigating the control options for an application.

The lit up active keys provide an easily navigable user interface almost self-explanatory in nature because of the limited number of selections the user can activate. Thus, the personal navigator reduces the need to read operator manuals because the amount of possible selections that a user may select is reduced and merely useful keys are illuminated.

The user interface 214 may present one or more applications 224 on the display 204 that correspond to a soft key by scrolling left-right in this example or up-down in another example with the arrow soft keys 246 to allow the device to control more applications than can be adequately displayed in space available on the display screen. The push-pull concept allows the user interface 214 to bring more options on the display 204 by scrolling left-right or up-down with these arrow keys 246 than can be adequately displayed on in the same available on the display screen.

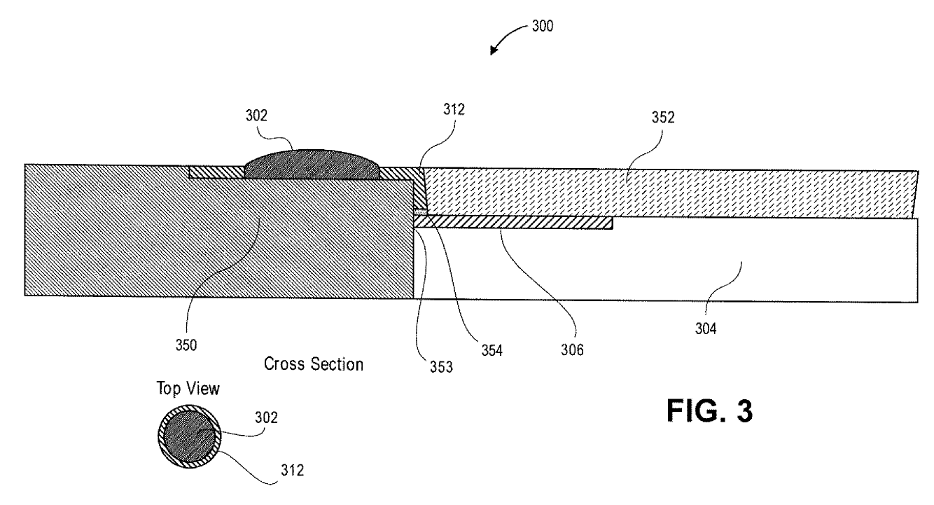

FIG. 3 illustrates an embodiment of a cross sectional view of hand-held remote-control having a plurality of soft keys illuminated by the display 304. The hand-held remote-control 300 may include a frame 350, one or more soft keys 302, one or more optical fiber sections 312, a display 304, a plexi-glass cover 352, as well as other components. The light from the from the face of a display screen illuminating a particular section of the display 304 is coupled through the optical fiber 312 to the transparent portion that is capable of being illuminated of the translucent soft key 302 or translucent ring of material around the soft key 302. Examples for sections of the display 304, from which light may be coupled to the optical fibers section 312, include an associated legend section 306 (as illustrated in FIG. 3) and/or a number of display pixels (or a dedicated display portion) 353 specifically used for selectively providing light to the optical fiber section 312. Each soft key 302 may have an optical fiber 312 to couple light to that soft key 302 according to its individually activated legend section 306 of the display 304. In an embodiment, the display 304 may be a Liquid Crystal Display or other similar display. The display 304 screen itself can be used as a sole light source for the translucent portion capable of being illuminated of the physical key portion of the first soft key 302.

A transfer point adapter 354 may be added between the legend section on the face of the display 304 and the optical fiber section 312 coupling light to the translucent portion of the physical key making up the soft key 302. The transfer point adapter 354 increases the amount of light routed from the display 304 to the soft key 302 by affixing the optical coupling of the optical fiber 312 to the display 304. The transfer point adapter may be made out of a soft material and act as an optical fiber cladding to increase the propagation of light through the optical fiber 312.

The optical fiber 312 may be made out of plexiglass or other similar material that is capable of carrying and guiding light. The optical fiber 312 may have a tubular structure made from plexi-glass or similar material, which is hollow inside the tube structure and either surrounded by a mirrored cladding or lined with a mirrored cladding. The optical fiber 312 may transfer light from that section of the display 304 the optical fiber 312 couples to.

The display 304 may be made up of multiple individual segments. Each segment of the display 304 may have the size equal to the size of the cross section of 1) an optical fiber and/or the size equal to the information inlet to the light buttons. (i.e. one mm² or percentage of same). The display 304, i.e. light source for the lit up buttons does not need to be viewable to the user just the light or color projected by the display 304 to the lit up buttons. The display lit soft keys 302 that have multiple states of activation potentially associated with each soft key 302 may be used with all sorts of devices rather than the example hand held remote described above.

Thus, some soft keys are selectively lit up in a particular color or intensity versus all of the keys being lit up at the powering on of the remote. Also, an interdependent connectivity exists between the display 304 screen information and the soft key 302 choices. A link exists between the lighting of the soft keys 302 and the execution status of that soft key. The display lit soft keys 302 allow a user to focus on ease of operation whilst providing off screen feedback of an executed task. The display lit soft keys 302 offer guidance in the selection of potential key choices that the user may select from. The navigation through a user interface becomes almost self-explanatory to a user reducing the need to read operating manuals.

The display screen 304 itself may be used as the light source for soft key 302 illumination. Accordingly, a separate light source for illumination of keys is not necessary, thereby causing no additional power consumption.

The display lit soft keys 302 can not only be used with a remote control but also with all electronic devices outfitted with a display screen or similar technology. The display lit soft keys 302 give intelligent instruction of how to use an application through the selection of keys for the execution of commands. The display lit soft keys 302 give this guidance through light or even images transported via the fiber optics and in the future possibly Braille.

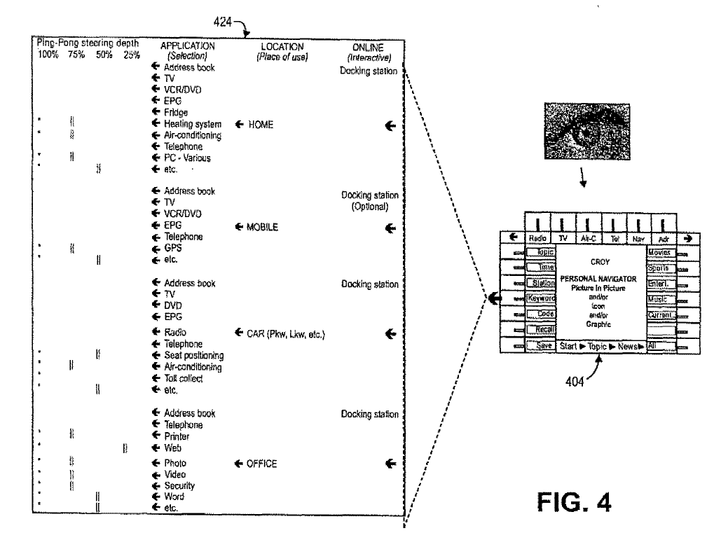

FIG. 4 illustrates the handheld using the personal navigator interface key lighting system may cooperate with docking systems in a mobile transportation environment such as a car and airplane, and in the home and office. The user interface presenting the personal navigator interface key lighting system on the display 404 and associated soft keys may work with a number of applications 424 to allow a user to control a particular application and guide the user on navigating through the control options for that system. The user interface gives the user a visual indication in lit up soft keys of what selection steps options are available to control that particular application. The eye visually picks out the interdependent soft keys lit or otherwise accentuated such as lit keys of different intensity of light, keys of different colors and keys of flashing patterns from non-lit keys as well as each type listed above. Since the device using the personal navigator interface key lighting system may cooperate with many applications in the home, car, office, and other locations, a user may be accustom to a consistent personal navigation interface to guide the user on navigating through the control options for any application by giving the user a visual indication in lit up keys of what selection steps options are available to control a particular application.

The personal navigation user interface provides intelligent instruction of an application 424 to the selection of soft keys for the execution of commands by accentuation through light or even images transported to the soft keys via the fiber optics. Note, the display may also illuminate Picture in Picture and/or Icons and/or other Graphic images.

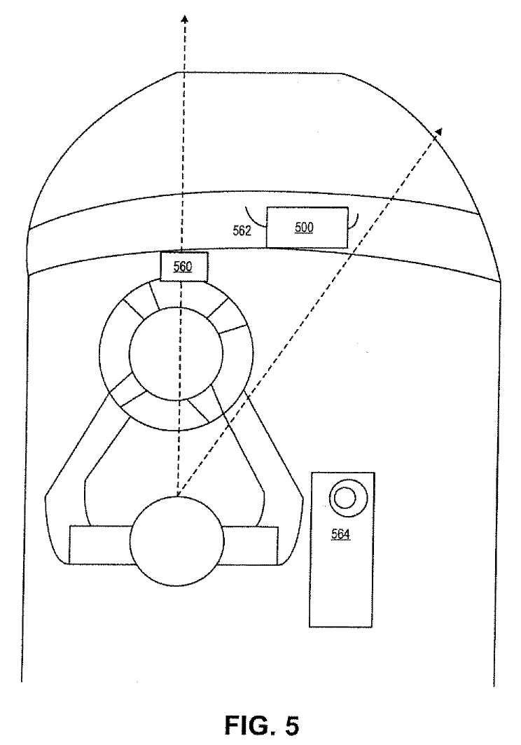

FIG. 5 illustrates an embodiment of a device having a display using the personal navigator interface key lighting system permanently installed in, for example, the dash board of the automobile. The device 500 has a display that couples to optical fibers to soft keys to implement the personal navigator interface soft key lighting system. Also, a handheld unit 500 using the personal navigator interface key lighting system may be placed in a docking station on the dashboard of the automobile. Once the device 500 is in place, a mechanical arm 562 that is part of the docking station or permanently installed in the dashboard of the automobile may control the viewing angle of the display. The device 500 has a wireless receiver to receive controls signals to assert the set of soft keys in the device 500. A viewing angle of the display of the device may be controlled by the mechanical arm 562. A device 560 with buttons and a wireless transmitter that can be clipped to a steering wheel may send control signals to the device 500. The received controls signals may also direct movement of the mechanical arm 562 to control the viewing angle of the display of the device 500. The mechanical arm 562 may move the display upward, downward, left and right to change a user's viewing angle of the display and soft keys. As discussed, controllers in the mechanical arm 562 may receive wireless control signals from the transmitter 560 clipped to the steering wheel to cause motors to move the mechanical arm and move the viewing angle of the display and soft keys. The controls signals can also come from many other devices 564 such as permanent switches, knobs such as an iDrive™, or other similar sources. The viewing angle of the display may be designed to keep the display and soft keys with multiple states of activation within set limits of the field of view of the driver. For example, the display may be within 20 degrees of the driver's forward looking range of vision and within 15 degrees of the driver's horizontal range of vision.

The activation of a soft key is normally effected via depressing the button with a finger. However the activation of a soft key can also be achieved via: Touch screen; i-Drive™; Speech recognition, steering wheel buttons; a computer mouse; wireless transmission; or similar activation technology. In particular, function(s) associated to a soft key may be selected and invoked by input means, such as those mentioned above. In such cases, activation may be achieved by, e.g., moving a cursor by means of an input device to a respective part in the legend section. In response thereto, the associated function of that legend section's part and, thus, the soft key is determined as activated. Then, soft key illumination may be seen or altered. Further embodiments may include providing a virtual form. In such embodiments, a control illuminated through soft keys may be displayed, as a whole, as graphics on a display (e.g. of a computer system, of an on-board information system of a vehicle). The also virtually provided soft keys may be activated as set forth above with reference to FIGS. 1 to 4 by, e.g., pressing/contacting a display portion that is linked via wired or wirelessly to a corresponding activated soft key. Soft keys may be also activated by operating an input device (such as indicated above) to select to be activated soft key. In cases where a pointing means (e.g. cursor) is provided, it may automatically be positioned at a display portion representing a selectable soft key or its movements and/or positioning may be limited to display positions for selectable soft keys.

In an embodiment, a device may include a display screen, a control unit being adapted to display on the display screen, a display, and a set of two or more soft keys. The soft keys each have an associated function in a legend section in the display. Each soft key in the set of soft keys comprises both a representation of a physical key having at least a portion that is capable of being illuminated and the representation of a physical key is associated with a current function in the legend section displayed in the display for representation of a physical key.

The physical portion capable of being illuminated is illuminated in order to visually indicate a state of the soft key, wherein when a state of the current function in the legend section associated with the soft key changes, then visually an illumination characteristic of the soft key changes through illumination of the portion of the representation of a physical key capable of being illuminated.

A user interface presents the current functions in the legend section in order to provide the visual indication in the set of soft keys that will guide a user on navigating through any control option for an application presented by the user interface by giving the user a visual indication in illumination of selected soft keys from the set of soft keys of what selection options are available to control that particular application.

The visual indication in illumination characteristic includes a change in color of the illuminated portion of the representation of a physical key, a change in an intensity of the light from the illuminated portion of the representation of a physical key, a pattern conveyed by a lighting sequence of the illuminated portion of the representation of a physical key, and combination thereof.

An operation of the set of two or more soft keys and illumination of those two or more soft keys is interdependent as other soft keys that are activated because as the initial soft key is activated that allows one or more new functions in the legend section to be enabled after the initial soft key is activated and illumination caused by the newly enabled selectable functions in the legend section causes one or more soft keys associated with the newly enabled selectable functions to now illuminate themselves as well as cause one or more soft keys associated with functions that are no longer available to not illuminate.

The user interface changes the illumination characteristic of merely a subset of the set of soft keys to ease a user's focus on the soft key selection from the set of potential soft keys to activate, and the subset of the set of soft keys having their illumination characteristic changed are soft keys that currently have an available function in the legend section associated with that soft key,

The user is guided to available commands associated with the application visually by illumination of both the functions in the legend section on the display and the illumination of the associated soft keys.

When a first soft key is asserted, then the first soft key may give a visual feedback signal that the first soft key has been asserted to provide assurance and ease of operation whilst providing off display screen feedback of an executed task.

The portion that is capable of being illuminated of a first soft key comprises a ring of translucent material being capable of being illuminated around the soft key.

The functions in the legend section are split up into distinct two or more parts including a first section of the legend section for applications controllable by the device and a second section of the legend section for command options a user may currently choose for a particular application selected in the first section of the legend section for applications.

The device is installed in an automobile and the device has a wireless receiver to receive controls signals to assert the set of soft keys in the device.

A mechanical arm controls a viewing angle of the display of the device and the received control signals also direct movement of the mechanical arm to control the viewing angle of the display.

An input device may activate at least one or more of the soft keys.

One or more applications are presented on a display that corresponds to a first soft key for a device in which the first soft key may comprise both a representation of a physical key having at least a portion that is capable of being illuminated and the representation of a physical key is associated with a current application displayed on the display for the first physical key.

One or more commands associated with a particular application are present once the particular application is selected by a user, wherein the one or more commands associated are associated with one or more soft keys in which each soft key may comprise both a representation of a physical key having at least a portion that is capable of being illuminated and the current command displayed on the display for that representation of a physical key.

A visual indication is provided through illumination of soft keys to guide a user on navigating through any control options for a particular application by giving the user a visual indication in illumination of selected soft keys of what current commands are available to control that particular application.

The visual indication in illumination includes a change in color of the illuminated portion of the representation of a physical key, a change in an intensity of the light from the illuminated portion of the representation of a physical key, a pattern conveyed by a lighting sequence of the illuminated portion of the representation of a physical key, and combination thereof.

One or more applications are present on a display that correspond to the soft key by at least one of scrolling left-right or up-down with an arrow key to allow the device to control more applications than can be adequately displayed in space available on the display.

An operation of the two or more soft keys and illumination of those two or more soft keys is configured as being interdependent on other soft keys being depressed by enabling one or more new commands to be displayed when a first soft key is asserted and altering an illumination of the one or more soft keys associated with the newly enabled selectable commands.

A user's focus on soft key selection from a set of potential soft keys to assert is eased by navigating a user to select soft keys that currently have an available function or an available application associated with that soft key in the set of potential keys by merely illuminating information in the legend section on the display associated with the application or the command and also illuminating the portion of the soft keys that is capable of being illuminated.

A user is guided to the available commands and available applications visually by illumination of both the legend section on the display of currently available commands and available applications and by the illumination of the associated soft keys with the currently available commands and available applications.

A user interface that presents multiple potential states of activation with the one or more soft keys for the device is provided, the first soft key is asserted via one of a physical touch, or a receipt of an external control signal and the first soft key gives a visual feedback signal that the first soft key has been asserted and placed into a particular state of activation to provide assurance and ease of operation whilst providing off display feedback of an executed task.

Although the present invention has been described with reference to specific exemplary embodiments, it will be evident that various modifications and changes may be made to these embodiments without departing from the broader spirit and scope of the invention as set forth in the claims. The hand-held remote-control may be part of a Cellular phone, a mini-computer or other similar device. The on-off power button may be a soft key. Accordingly, the specification and drawings are to be regarded in an illustrative rather than a restrictive sense.

What is claimed is:

1. An apparatus, comprising:
a display;
a set of two or more soft keys that have an associated function in a legend section on the display; where a first soft key in the set of soft keys includes both a physical key having at least a portion that is capable of being illuminated and the physical key is associated with a current function in the legend section displayed on the display for that physical key;
one or more optical fibers to propagate light emitted from a portion of the display to the portion capable of being illuminated of a corresponding soft key, where each physical key that has a portion capable of being illuminated receives the light from at least one of the optical fibers and the light projects through the display and propagates through an optical fiber to the soft key associated with that optical fiber in order to visually indicate a state of the soft key, wherein when a state of the current function in the legend section associated with the soft key changes, then visually an illumination characteristic of the soft key changes through illumination of the portion of the physical key capable of being illuminated; and
a user interface to present the current functions in the legend section in order to provide the visual indication in the set of soft keys that will guide a user on navigating through any control options for an application presented by the user interface by giving the user a visual indication in illumination of selected soft keys from the set of soft keys of what selection options are available to control that particular application.

2. The apparatus of claim 1, wherein the visual indication in illumination characteristic includes a change in color of the illuminated portion of the physical key, a change in an intensity of the light from the illuminated portion of the physical key, a pattern conveyed by a lighting sequence of the illuminated portion of the physical key, and combination thereof.

3. The apparatus of claim 1, wherein an operation of the set of two or more soft keys and illumination of those two or more soft keys is interdependent as other soft keys are depressed because as the initial soft key is depressed that allows one or more new functions in the legend section to be enabled after the initial soft key is depressed and illumination caused by the newly enabled selectable functions in the legend section causes one or more soft keys associated with the newly enabled selectable functions to now illuminate themselves as well as cause one or more soft keys associated with functions that are no longer available to not illuminate.

4. The apparatus of claim 1, wherein the user interface changes the illumination characteristic of merely a subset of the set of soft keys to ease a user's focus on the soft key selection from the set of potential soft keys to depress, and the subset of the set of soft keys having their illumination characteristic changed are soft keys that currently have an available function in the legend section associated with that soft key.

5. The apparatus of claim 1, wherein the user is guided to available commands associated with the application visually by illumination of both the functions in the legend section on the display and the illumination of the associated soft keys.

6. The apparatus of claim 1, wherein when a first soft key is asserted, then the first soft key may give a visual feedback signal that the first soft key has been asserted to provide assurance and ease of operation whilst providing off display screen feedback of an executed task.

7. The apparatus of claim 1, wherein the physical portion that is capable of being illuminated of a first soft key comprises a ring of translucent material around the soft key and a first optical fiber couples to the display at the legend section associated with the first soft key.

8. The apparatus of claim 1, wherein an optical fiber couples light from a face of a display screen to the portion that is capable of being illuminated of a first soft key via a transfer point adapter and the display screen itself is used as a sole light source for the portion capable of being illuminated of the physical key portion of the first soft key.

9. The apparatus of claim 1, wherein the functions in the legend section are split up into distinct two or more parts including a first section of the legend section for applications controllable by the apparatus and a second section of the legend section for command options a user may currently choose for a particular application selected in the first section of the legend section for applications.

10. The apparatus of claim 1, wherein the apparatus is installed in an automobile and the apparatus has a wireless receiver to receive controls signals to assert the set of soft keys in the apparatus.

11. The apparatus of claim 10, wherein a mechanical arm controls a viewing angle of the display of the apparatus and the received controls signals also direct movement of the mechanical arm to control the viewing angle of the display.

12. A method, comprising:
presenting one or more applications on a display that corresponds to a first soft key for a device in which the first soft key may include both a physical key having at least a portion that is capable of being illuminated and the physical key is associated with a current application displayed on the display for the physical key;
presenting one or more commands associated with a particular application once the particular application is selected by a user, wherein the one or more commands associated are associated with one or more soft keys in which each soft key may include both a physical key having at least a portion that is capable of being illuminated and the current command displayed on the display for that physical key; and
providing a visual indication through illumination of soft keys to guide a user on navigating through any control options for a particular application by giving the user a visual indication in illumination of selected soft keys of what current commands are available to control that particular application.

13. The method of claim 12, wherein the visual indication in illumination includes a change in color of the illuminated portion of the physical key, a change in an intensity of the light from the illuminated portion of the physical key, a pattern conveyed by a lighting sequence of the illuminated portion of the physical key, and combination thereof.

14. The method of claim 12, further comprising:
presenting one or more applications on a display that correspond to the soft key by at least one of scrolling left-right or up-down with an arrow key to allow the device to control more applications than can be adequately displayed in space available on the display.

15. The method of claim 12, further comprising:
configuring an operation of the two or more soft keys and illumination of those two or more soft keys as being interdependent on other soft keys being depressed by enabling one or more new commands to be displayed when a first soft key is asserted and altering an illumination of the one or more soft keys associated with the newly enabled selectable commands.

16. The method of claim 12, further comprising:
easing a user's focus on soft key selection from a set of potential soft keys to assert by navigating a user to select soft keys that currently have an available function or an available application associated with that soft key in the set of potential keys by merely illuminating information in the legend section on the display associated with the application or the command and coupling the illumination from the display to the portion of the physical keys that is capable of being illuminated.

17. The method of claim 12, further comprising:
guiding a user to the available commands and available applications visually by illumination of both the legend section on the display of currently available commands and available applications and by the illumination of the associated soft keys with the currently available commands and available applications.

18. The method of claim 12, further comprising:
providing a user interface that presents multiple potential states of activation with the one or more soft keys for the device, wherein the first soft key is asserted via one of a physical touch, or a receipt of an external control signal and the first soft key gives a visual feedback signal that the first soft key has been asserted and placed into a particular state of activation to provide assurance and ease of operation whilst providing off display feedback of an executed task.

19. An apparatus, comprising:
means for presenting one or more applications on a display that corresponds to a set of one or more soft keys for a device in which a first soft key may consist of both a physical key having at least a portion that is capable of being illuminated and the physical key is associated with a current application displayed on the display for the first physical key; and
means for guiding a user on navigating through any control options for a first application by giving the user a visual indication in illumination of selected soft keys from the set of soft keys of what selection options are available to control the first application, wherein each soft key in the set of soft keys has multiple states of activation potentially associated with that soft key and is illuminated by light coming from the display.

20. The apparatus of claim 19, further comprising:
means for guiding a user to the available commands and available applications visually by illumination of both the legend section on the display of currently available commands and available applications and by the illumination of the associated soft keys with the currently available commands and available applications.
